(19) United States
(12) Patent Application Publication
(10) Pub. No.: US 2002/0078181 A1
(43) Pub. Date: Jun. 20, 2002

(54) Apparatus and method for reading data from a data carrier and data carrier for use in the apparatus and method

(75) Inventors: Menno Anne Treffers, Eindhoven (NL); Jacobus Petrus Josephus Heemskerk, Eindhoven (NL)

Correspondence Address: U.S. Philips Corporation, Corporate Patent Counsel, 580 White Plains Road, Tarrytown, NY, 10591, US

(73) Assignee: Koninklijke Philips Electronics N.V.

(21) Appl. No.: 10/023,250

(22) Filed: Dec. 18, 2001

(30) Foreign Application Priority Data
Dec. 20, 2000 (EP) 00204655.5

(51) Int. Cl. G06F 15/16

(52) U.S. Cl. 709/219

(57) ABSTRACT

The invention relates to an apparatus for reading data from a data carrier and for processing said read data, to an apparatus for storing address data and to a data carrier for storing data. When playing back a CD, additional services may be available on the Internet. To access these services, the address of the publisher's web-site has to be known to the playback apparatus. Therefore, according to the invention it is proposed that an apparatus for reading data from a data carrier comprises:

reading means for reading data to be reproduced and a data identifier identifying said data from said data carrier, transmitting means for transmitting said data identifier to a central database requesting further information related to said read data, receiving means for receiving a response message from said central database, which message comprises an address of an information database storing said further information and/or said further information requested by said central database from said information database while using said data identifier, and processing means for processing said further information received from said information database via said central database or requested from said information database while using said address received from said central database.

The address of the publisher's web-site can then be readily accessed and updated. Moreover, the storage format need not be changed to enable storage of the address of the central database on the data carrier. Finally, the use of this method is backwards compatible, that is, it is also effective for already sold data carriers.

The invention relates to an apparatus for reading data from a data carrier and for processing such read data, to an apparatus for storing address data comprising addresses of information databases storing further information related to data stored on data carriers, to corresponding methods and to a data carrier for storing data to be read and processed.

Publishers of data, in particular publishers of music and video data, preferably published on data carriers like CDs and DVDs, are looking for ways to provide additional services via the internet. Examples of such services are:

offering background information about track, such as names of musicians, composer, equipment used for recording, actors, . . .

selling the song text,

making special offers for related data carriers,

offering “milage points” for each data carrier purchased and providing an award system (“with 50 milage points you earn a free CD”),

selling special bonus tracks in compressed format exclusively to users of a particular data carrier.

Several conditions have to be met before this can work: the data carrier needs data identifiers that uniquely identify the data stored thereon, for example, that identifies a given music title to be read and replayed. Furthermore, the data carrier may use a unique carrier identifier that uniquely identifies each individual data carrier. This carrier identifier is used, for example, to make sure that only owners of a genuine carrier can get benefits but not the owners of a copy. Furthermore, it may identify the distribution channel, for example, the retail shop through which the carrier was purchased, thus allowing financial benefits for participating retailers. Another condition is that the address of an information database, for example, the internet address of the publisher's web-site, has to be known to the playback apparatus.

A straightforward solution to meet the latter condition is to write the address of the information database directly on the data carrier. The playback apparatus could then read this address and use it to access the information data base; for example, it could use the internet address to access the web-site. However, this approach involves two problems: the first problem is that a publisher needs to keep this web-site functional for a long time. An address of an information database that has been written to a data carrier has to be kept operational. The second problem is that this solution does not work for data carriers that have already been published.

A central database of audio CD and MP3 information is known as “GraceNote” which can be found in the internet under the address http://www.gracenote.com. Each time a CD or MP3 is played back on a computer, the computer can access this central data base through the internet for information about that specific data which is played back. This central database thus serves at the same time as an information database collecting and providing information related to data stored on audio CDs. To use this service a gracenote-enabled player has to be used on the computer. Although this central database does collect a large amount of information related to audio data and provided automatically when playing back an audio CD, this solution does not make use of all the information that is stored within the internet.

Therefore, it is an object of the present invention to provide a solution to the above mentioned problems, that is, to provide a solution such that it is not necessary to store specific addresses of information databases on the data carrier and that it also works for data carriers that have already been published. Furthermore, a solution should be provided that utilizes as much as possible information distributed all over a network such as, for example, the internet.

This object is achieved by an apparatus for reading data as claimed in claim 1 or 2, by an apparatus for storing address data as claimed in claim 9 or 10, by the corresponding methods as claimed in claim 17, 18 or 19, and by a data carrier for storing data as claimed in claim 20 or 21.

The solution is based on the idea to define a single address of a central database instead of writing the specific address of each different information database on each data carrier. Each playback apparatus then uses this single address of the central database to access the information database so as to derive further information related to the data stored on and processed from the data carrier. This single address could be stored on each data carrier or, alternatively, in the playback apparatus itself.

The procedure for reaching the information database would then be that at first the playback device sends a query to the central database whose address may be mentioned in the format standard of the data carrier. This query contains at least a data identifier identifying the data stored on the data carrier or a part thereof which should be processed. The central database then uses this data identifier to look up the current address of the information database and returns it to the playback apparatus or informs the latter that no additional service is available. The playback apparatus can then query the information database, using the received address therefrom, so as to acquire further information related to the read data and can subsequently processes this received further information. Additionally, or alternatively instead of returning the address of the information database to the playback apparatus, the central database could also use this address to directly contact the information database, to retrieve the required further information therefrom and pass this further information on to the playback apparatus for processing. This procedure prevents the address of an information database from becoming out-dated. When an address of an information database has to change, only its entry in the central database has to be updated.

All kinds of further information may be received from the information databases, including, for example, additional audio tracks to be played on the playback apparatus, song texts to be displayed on a display, or digital key information enabling access to information on the data carrier otherwise not accessible.

In a preferred embodiment said central database and said information database are servers connected via a network, in particular servers connected via the internet. The address of the information database would then comprise the internet address thereof, in particular the URL (Uniform Resource Locator) stored in the central database. The central database could then be accessed by way of a single URL stored on the data carrier; such an URL could be identical on all data carriers.

The playback apparatus could be a separate apparatus connected to the internet via a computer, the playback apparatus then being connected to the computer, or alternatively could include its own means for connecting to the internet without the aid of an additional computer. The playback apparatus could also be included in a computer by means of certain hardware and software. The display of the computer can then be used to display the further information when required.

In a further embodiment of the invention not only a data identifier is used and transmitted to the central database, but additionally an apparatus identifier identifying the playback apparatus and/or a carrier identifier identifying the data carrier which is played back is transmitted to the central database. This will make the information collected by the central database more valuable; such information could, for example, be used in an award system as described above or as information concerning customers' interests and their purchasing habits. Since each query for further information passes through the central database, the information collected by this database is valuable and can be used for further purposes.

Moreover, the address of the information database, or information retrieved from that information database may only be provided to a playback apparatus which is registered. Otherwise, when not registered, an address of a default information database or of a database comprising less information may be provided.

Such information could be gathered by using given information collection means included in the central database, and such information could also be sold to other commercial services like market research institutes.

In an embodiment of the invention the data carrier is a digital data carrier comprising audio information such as a CD, DVD or SACD disc or a flash card as commonly used. But the data carrier could also be any other data carrier storing data to be read and processed by an appropriate apparatus. The digital data carrier comprising audio information may be read by a CD or DVD player connected to the central database. These players may be stand-alone devices or may, alternatively, be built into a computer. Using given software on a computer, CD or DVD drives built into personal computers can be used to playback audio and video CDs or DVDs, respectively. Since many computers already have a connection to the internet, the invention can be used thereon just by employing given player software that uses the data identifier as proposed according to the invention.

According to a further aspect of the invention said data identifier comprises a title identifier identifying a title to be read and processed from the data carrier, in particular a title of a piece of music or video. According to this aspect of the invention, for each title specific address information can be stored on the central database so that for each individual title further information related to that title can be provided to the user. Such a title identifier is, for example, a track identifier on CD- and DVD-discs. This track identifier may be stored on a data carrier in a header of the data file that contains audio data, for example in MP3 format. Alternatively it may be stored in the sub-code of a track on a CD conforming to the “Red Book”, in the sub-headers of sectors on a data CD, encoded in the least-significant bits of Linear PCM coded audio data, or in the payload of a robust watermark. Yet alternatively, a robust hash or fingerprint can be computed from data stored on the data carrier which can be used as an identifier.

The address of the central database may be stored on the data carrier itself. However, alternatively, the address of the central database may be stored in the apparatus. The invention does not require a change in any format of a data carrier, for example, the disc format. Furthermore, the invention is also effective for data carriers that have already been published. Publishers can change the address of their information databases, that is, of their servers. Only one address has to be kept operational, being the address of the central database. Since each query for further information goes through the central database the information collected by this database is valuable and can be used further.

It is to be understood that the method of reading data, the method of storing address data and the data carrier for storing data can be developed further and may have further embodiments identical or similar to those described above with reference to the apparatus for reading data and the apparatus for storing address data.

The objects, features and advantages of the invention will now be explained in greater detail with reference to the following figures, in which

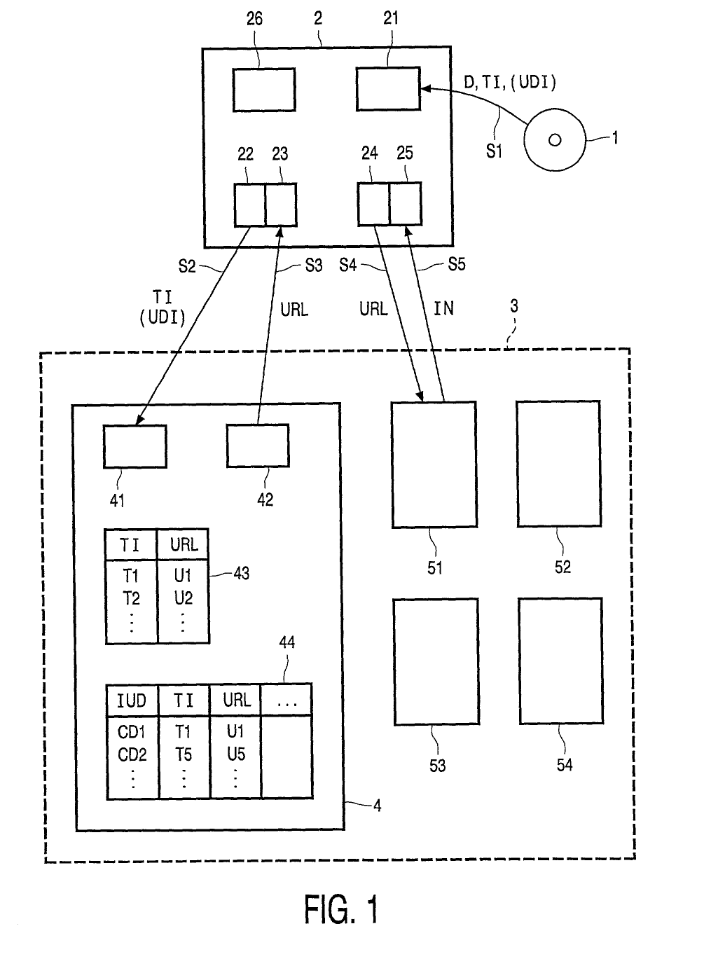

FIG. 1 shows a block diagram illustrating a first embodiment of a system in accordance with the invention,

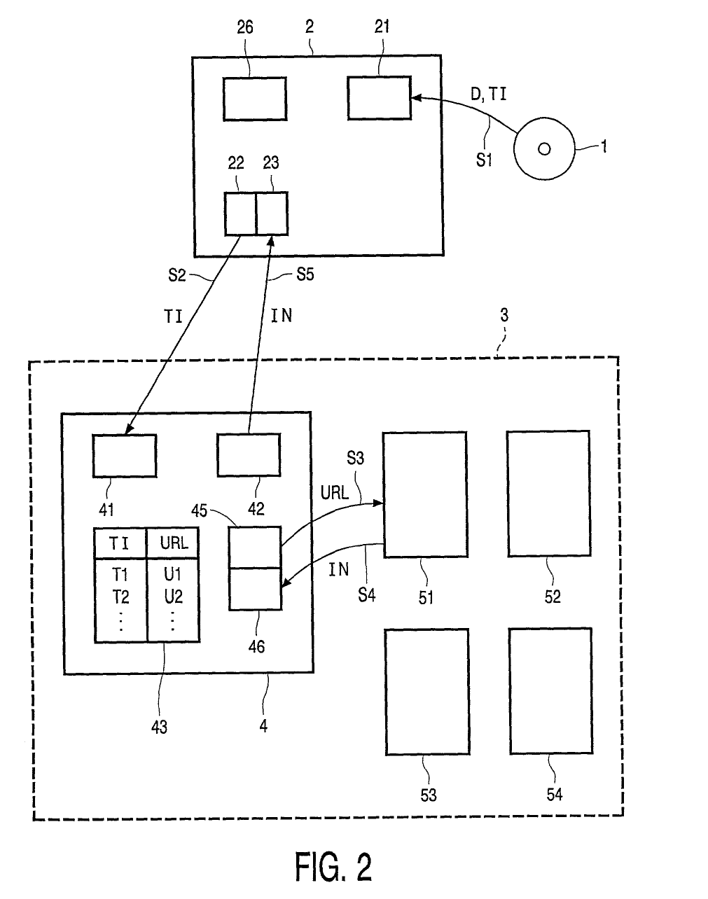

FIG. 2 shows a block diagram illustrating a second embodiment of a system in accordance with the invention, and

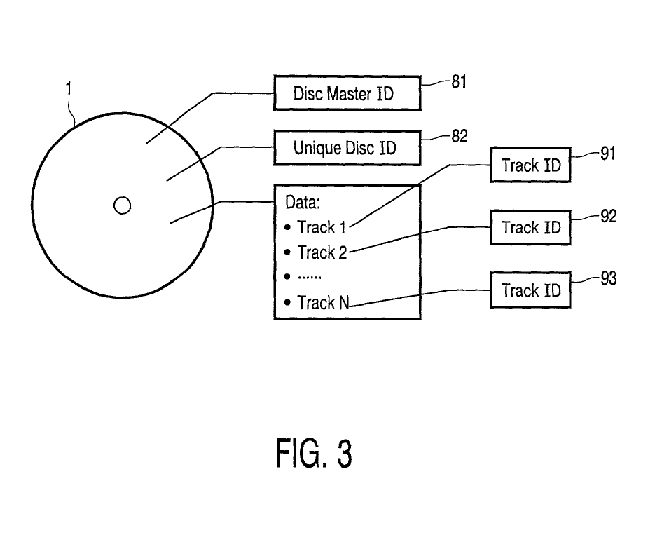

FIG. 3 shows schematically an embodiment of a data carrier in accordance with the invention.

FIG. 1 shows a playback apparatus 2 according to the invention for reading and reproducing data stored on a data carrier 1, e. g. a CD or a DVD, an apparatus 4 according to the invention for storing address data as a central database and several servers 51, 52, 53, 54 serving as information databases. The central database server 4 as well as the information database servers 51, 52, 53, 54 are part of a network 3 such as the Internet. The steps for performing the method according to the invention will now be explained. In a first step S1 data D to be reproduced, for example, a music title, are read from the data carrier 1 by reading means 21 of the playback apparatus. A data identifier TI, which may be a title identifier identifying the title to be reproduced, is read together with the data D. In step S2 this data identifier TI is transmitted from transmitting means 22 of the playback apparatus 2 to corresponding receiving means 41 of the central database server 4. The server 4 stores a reference table 43 in which addresses URL of information databases are assigned to data identifiers TI. In step S3 the address assigned to the transmitted data identifier TI is looked up in this table and transmitted back to the playback apparatus 2, that is, from transmission means 42 of the central database server 4 to corresponding receiving means 23 of the playback apparatus. According to the invention in step S4 the address URL is used by further transmitting means 24 to contact the information database server 51 which is identified by the address URL which will then return the requested further information IN to further receiving means 25 of the playback apparatus 2 in step S5. This further information IN, being stored on the information database server 51 and related to the data D read from the data carrier 1 in step S1, can then be displayed by display means 26, thus giving the user additional information like the music title, the musician, the composer, their pictures, and any other background information.

The central database server 4 in the present embodiment also comprises information collection means 44 for collecting additional information. For these reasons a unique carrier identifier UDI, like a unique disc identifier as stored on most CDs or DVDs, can be read by the reading means 21 of the playback apparatus 2 and transmitted to the central database server 4. This unique carrier identifier UDI can then be stored in the data collection means 44 together with, for example, the data identifier TI and the requested address URL. Other information, like an apparatus identifier uniquely identifying the playback apparatus 2 requesting the information from the central database 4 and other identifiers identifying, for example, the distribution channel of the data carrier, can also be stored as a kind of statistical information. This information can be used as marketing information or in a benefit award system where given users or retailers are awarded benefits for buying or selling data carriers.

FIG. 2 shows a block diagram of a further embodiment of the invention. Therein, the address URL of the information database server 51 is not directly transferred back to the playback apparatus 2 but is used instead by appropriate transmitting means 45 of the central database server 4 to contact the information database server 51 directly in step S3 so as to return the requested information IN to appropriate receiving means 46 of the central database server 4 in step S4. The received information IN is then transferred back from the transmitting means 42 to the receiving means 23 of the playback apparatus 2 in step S5 so as to be displayed to the user. In this embodiment the central database server acts as a gateway to the information data base servers 51, 52, 53, 54. The central database server 4 would receive all queries, pass them on to the information database servers 51, 52, 53, 54 and pass the answers back to the playback apparatus 2. This would make the information gathered by the central database server even more valuable.

FIG. 3 shows schematically an embodiment of a data carrier 1 according to the invention. The data carrier 1 holds a Disc Master ID 81 which is identical for all data carriers of identical contents and a Unique Disc ID 82 which is different for each individual copy of the data carrier. Both the Disc Master ID 81 and the Unique Disc ID 82 may be used as either the data identifier or the carrier identifier. When these identifiers are used as a data identifier, only further information related to the contents of the entire data carrier may be requested. When the Unique Disc ID 82 is used as a carrier identifier it creates, for example, the possibility to identify the shop in which the data carrier was purchased. The data carrier 1 also comprises a Track ID 91 . . . 93 for each track on the data carrier. When a Track ID 91 is used as a data identifier, further information related to each individual track can be requested. This is especially advantageous when the contents of the data carrier 1 consist of tracks copied from different original data carriers. The Track IDs 91 . . . 93 may comprise just a single identifier or may be composed of a combination of identifiers such as, for example, the original Disc Master ID, the original Unique Disc ID, a Purchase Transaction ID, etc. It is to be noted that not all IDs shown for this embodiment of the invention need be present on the data carrier 1. Data carriers comprising only a sub-set of the IDs shown in this embodiment can also be used.

The invention is not limited to the embodiments shown and described above. Various further embodiments and versions of the elements shown are also possible. The invention is also not limited to a specific kind of data carrier, to a specific apparatus for reading data from a data carrier or to a specific apparatus used as a central database server. The word “comprise” and its conjugations do not exclude the presence of elements or steps other than those listed in the claims. In de claims, any reference sign placed between parentheses shall not be construed as limiting the claims.

1. An apparatus (2) for reading data from a data carrier and for processing such read data, comprising:
reading means (21) for reading data to be processed and for reading a data identifier identifying said data from said data carrier (1),
transmitting means (22) for transmitting said data identifier to a central database (4) requesting further information related to said read data,
receiving means (23) for receiving a response message from said central database, which message comprises an address of an information database (51) storing said further information, and
processing means (26) for processing said further information received from said information database (51) and requested from said information database (51) while using said address received from said central database (4).

2. An apparatus (2) for reading data from a data carrier and for processing such read data, comprising:
reading means (21) for reading data to be processed and for reading a data identifier identifying said data from said data carrier (1),
transmitting means (22) for transmitting said data identifier to a central database (4) requesting further information related to said read data,
receiving means (23) for receiving a response message from said central database, which message comprises said further information requested by said central database (4) from an information database (51) storing said further information, and
processing means (26) for processing said further information received from said information database (51) via said central database (4).

3. An apparatus as claimed in claim 2, wherein said response message from said central database (4) also comprises an address of the information database (51) storing said further information.

4. An apparatus as claimed in claim 1 or 2, wherein said central database (4) and said information database (51) are servers connected via a network, in particular servers connected via the Internet.

5. An apparatus as claimed in claim 1 or 2, wherein said reading means (21) is operative to read data representing a block of audio information and to read a data identifier identifying said block of audio information from the data carrier (1).

6. An apparatus as claimed in claim 1, 2 or 5, wherein said further information comprises data representing a block of audio information and wherein said processing means (26) is operative to reproduce said block of audio information.

7. An apparatus as claimed in claim 1 or 2, wherein said processing means (26) is operative to display information on a monitor of a computer.

8. An apparatus as claimed in claim 1 or 2, wherein said transmitting means (22) is operative to transmit an apparatus identifier identifying the apparatus and/or a carrier identifier identifying the data carrier (1).

9. An apparatus (4) for storing address data comprising addresses of information databases, said information databases storing further information related to data stored on data carriers, said apparatus comprising:
receiving means (41) for receiving a data identifier identifying said data stored on a data carrier from an apparatus (2) reading said data and said data identifier from said data carrier (1), and
transmitting means (42) for transmitting a response message to said apparatus (2), which message comprises an address of an information database (51) storing said further information.

10. An apparatus (4) for storing address data comprising addresses of information databases, said information databases storing further information related to data stored on data carriers, said apparatus comprising:
receiving means (41) for receiving a data identifier identifying said data stored on a data carrier from an apparatus (2) reading said data and said data identifier from said data carrier (1), and
transmitting means (42) for transmitting a response message to said apparatus (2), which message comprises said further information requested from said information database (51) using said data identifier.

11. An apparatus as claimed in claim 10, wherein said response message to said apparatus (2) also comprises an address of an information database (51) storing said further information.

12. An apparatus as claimed in claim 9 or 10, wherein the apparatus and said information database (51) are servers connected via a network, in particular servers connected via the Internet.

13. An apparatus as claimed in claim 9 or 10, also comprising information collection means (44) for collecting information concerning the requests for further information from the apparatus (2), in particular using said data identifier, an apparatus identifier identifying the playback apparatus and/or a carrier identifier identifying the data carrier received from said apparatus (2).

14. An apparatus as claimed in any of the preceding claims, wherein said data carrier (1) is a digital data carrier, in particular a CD, DVD, SACD or flash card.

15. An apparatus as claimed in any of the preceding claims, wherein said address of the information database (51) comprises the Internet address, in particular the URL, of said information database.

16. An apparatus as claimed in any of the preceding claims, wherein said data identifier comprises a title identifier identifying a title of the data to be read from the data carrier (1), in particular a title of a piece of music or video.

17. A method for reading data from a data carrier and for processing such read data, comprising the steps of:
reading data to be processed and a data identifier identifying said data from said data carrier (1),
transmitting said data identifier to a central database (4) requesting further information related to said read data,
receiving a response message from said central database (4), which message comprises an address of an information database (51) storing said further information, and
processing said further information received from said information database (51) and requested from said information database (51) while using said address received from said central database (4).

18. A method for reading data from a data carrier and for processing such read data, comprising the steps of:
reading data to be processed and a data identifier identifying said data from said data carrier (1),
transmitting said data identifier to a central database (4) requesting further information related to said read data,
receiving a response message from said central database (4), which message comprises said further information requested by said central database (4) from an information database (51) storing said further information, and
processing said further information received from said information database (51) via said central database (4).

19. A method for storing address data comprising addresses of information databases, said information databases storing further information related to data stored on data carriers, said method comprising the steps of:
receiving a data identifier identifying said data stored on a data carrier (1) from an apparatus (2) reading said data and said data identifier from said data carrier (1), and
transmitting a response message to said apparatus (2), said response message comprising an address of an information database (51) storing said further information and/or comprising said further information requested from said information database (51) while using said data identifier.

20. A method for providing access to information databases, said information databases storing further information related to data stored on data carriers, said method comprising the steps of:
receiving a data identifier identifying said data stored on a data carrier (1) from an apparatus (2) reading said data and said data identifier from said data carrier (1), and
transmitting a response message to said apparatus (2), said response message comprising an address of an information database (51) storing said further information and/or comprising said further information requested from said information database (51) while using said data identifier.

21. A data carrier for storing data to be read and processed by an apparatus as claimed in claim 1 or 2 and for storing a data identifier identifying said data, said data identifier being provided for transmission to a central database requesting further information related to said read data and for reception of a response message from said central database, which message comprises an address of an information database storing said further information and/or said further information requested by said central database from said information database while using said data identifier, said further information received from said information database via said central database or requested from said information database while using said address received from said central database being provided for processing by said apparatus.

22. A data carrier for storing data to be read and processed by an apparatus as claimed in claim 1 or 2 and for storing a carrier identifier identifying the data carrier, said carrier identifier being provided for transmission to a central database.

23. A method according to claim 19 or 20, comprising the step of associating an address of an information database (51) with one or more data identifiers.

24. A method according to claim 22, comprising the step of requesting a fee from an operator of the information database in return for said associating.

25. A method according to claim 9 or 10, wherein the contents of the response message is dependent on whether or not the apparatus (2) reading said data is registered.
